(19) United States
(12) Patent Application Publication
(10) Pub. No.: US 2018/0209288 A1
(43) Pub. Date: Jul. 26, 2018

(54) BRAZE SYSTEM, BRAZED ARTICLE, AND METHOD FOR FORMING A BRAZED ARTICLE

(71) Applicant: GENERAL ELECTRIC COMPANY, Schenectady, NY (US)

(72) Inventors: Brian Leslie HENDERSON, Simpsonville, SC (US); Paul A. COOK, Greenville, SC (US); Daniel James DORRIETY, Travelers Rest, SC (US)

(21) Appl. No.: 15/416,691

(22) Filed: Jan. 26, 2017

(51) Int. Cl. F01D 11/00; B23K 1/00; B23K 35/30; B32B 15/01

(52) U.S. Cl. CPC F01D 11/005; B23K 1/0018; F05D 2230/237; B23K 35/3046; B32B 15/017; B23K 35/3033

(57) ABSTRACT

A braze system is disclosed, including a first surface, a second surface, a gap disposed between the first surface and the second surface, a capillary matrix disposed in the gap, and a braze material disposed in contact with the capillary matrix. The capillary matrix includes a matrix structure forming a plurality of capillaries. A brazed article is disclosed in which the braze material is disposed within the plurality of capillaries and contacts the first surface and the second surface. The braze material, the capillary matrix, the first surface, the second surface, and the gap form a brazed portion including less than about 20% voiding. A method for forming a brazed article includes disposing the capillary matrix into the gap, and infusing a braze material into the plurality of capillaries and in contact with the first surface and the second surface, forming the brazed portion.

### FIELD OF THE INVENTION

The present invention is directed to braze systems, brazed articles, and methods for forming brazed articles. More particularly, the present invention is directed to braze systems, brazed articles, and methods for forming brazed articles including a capillary matrix.

### BACKGROUND OF THE INVENTION

Hard-to-weld (HTW) alloys, such as nickel-based superalloys and certain aluminum-titanium alloys, due to their gamma prime and various geometric constraints, are susceptible to gamma prime strain aging, liquation and hot cracking. These materials are also difficult to join when the gamma prime phase is present in volume fractions greater than about 30%, which may occur when aluminum or titanium content exceeds about 3%. As used herein, an “HTW alloy” is an alloy which exhibits liquation, hot and strain-age cracking, and which is therefore impractical to weld.

Non-weldable (NW) alloys, are typically precipitation hardenable or solid-solution strengthened alloys which cannot be practically welded in an industrial setting and at an industrial scale, are only weldable under prohibitively extreme conditions, and, as such, are generally regarded as not being weldable. As used herein, an “NW alloy” refers to alloys having titanium-aluminum equivalents (or combined percents of composition, by weight) of about 4.5 or higher. NW alloys may include nickel-based alloys in which the primary hardening mechanism is via the process of precipitation, cobalt alloys which are solid solution strengthened, and alloys which require heating immediately prior to and during welding to at least about 1,000° C.

These HTW and NW alloys may be incorporated into components of gas turbine engines such as seal slots, airfoils, blades (buckets), nozzles (vanes), shrouds, shroud seal slots, combustors, transitions pieces, transition piece seal slots, rotating turbine components, wheels, seals, and other hot gas path components. Incorporation of these HTW alloys may be desirable due to often superior operational properties, particularly for certain components subjected to the most extreme conditions and stresses. However, the poor weldability inherent in HTW and NW alloys complicates joining, servicing, and repairing components incorporating these alloys.

Additionally, joining, servicing, or repairing components, including components of gas turbine engines, may require the brazing of a gap up to about half of an inch wide. By way of example, a component may include an undesirable feature which is removed by machining, leaving a wide gap. However, brazing of wide gaps with standard braze materials, pastes, foils, tapes, pre-sintered preforms, or flux powder may lead to undesirable or unacceptable porosity, cracking, lack of bonding, or formation of eutectic phases. This may be exacerbated if the base materials being braised are HTW or NW alloys.

### BRIEF DESCRIPTION OF THE INVENTION

In an exemplary embodiment, a braze system includes a first surface, a second surface, a gap disposed between the first surface and the second surface, a capillary matrix disposed in the gap, and a braze material disposed in contact with the capillary matrix. The capillary matrix includes a matrix structure forming a plurality of capillaries.

In another exemplary embodiment, a brazed article includes a first surface, a second surface, a gap disposed between the first surface and the second surface, a capillary matrix disposed in the gap, and a braze material. The capillary matrix includes a matrix structure forming a plurality of capillaries, and the braze material is disposed within the plurality of capillaries and contacts the first surface and the second surface. The braze material, the capillary matrix, the first surface, the second surface, and the gap form a brazed portion including less than about 20% voiding.

In another exemplary embodiment, a method for forming a brazed article includes disposing a capillary matrix into a gap between a first surface and a second surface. The capillary matrix includes a matrix structure forming a plurality of capillaries, and a braze material is infused into the plurality of capillaries. The braze material contacts the first surface and the second surface, forming a brazed portion.

Other features and advantages of the present invention will be apparent from the following more detailed description of the preferred embodiment, taken in conjunction with the accompanying drawings, which illustrate, by way of example, the principles of the invention.

### BRIEF DESCRIPTION OF THE DRAWINGS

FIG. 1 is a schematic view of a braze system, according to an embodiment of the present disclosure.

FIG. 2 is a schematic view of a brazed article, according to an embodiment of the present disclosure.

Wherever possible, the same reference numbers will be used throughout the drawings to represent the same parts.

### DETAILED DESCRIPTION OF THE INVENTION

Provided are exemplary braze systems, brazed articles, and methods for forming brazed articles. Embodiments of the present disclosure, in comparison to braze systems, brazed articles, and methods for forming brazed articles not utilizing one or more features disclosed herein, decrease costs, increase process control, increase reparability, improve mechanical properties, improve elevated temperature performance, increase joining capability, increase joint quality, increase durability, increase strength, decrease eutectic formation, decrease voiding, or a combination thereof.

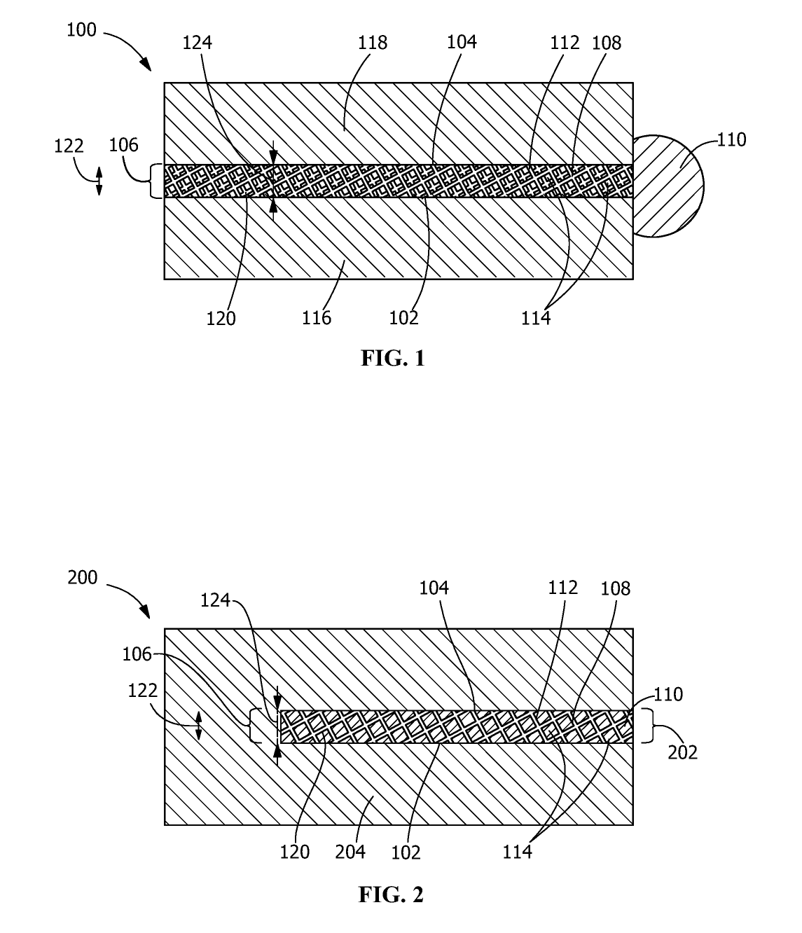

Referring to FIG. 1, in one embodiment, a braze system 100 includes a first surface 102, a second surface 104, a gap 106 disposed between the first surface 102 and the second surface 104, a capillary matrix 108 disposed in the gap 106, and a braze material 110 disposed in contact with the capillary matrix 108. The capillary matrix 108 includes a matrix structure 112 forming a plurality of capillaries 114.

Referring to FIG. 2, in one embodiment, a brazed article 200 includes a first surface 102, a second surface 104, a gap 106 disposed between the first surface 102 and the second surface 104, a capillary matrix 108 disposed in the gap 106, and a braze material 110. The capillary matrix 108 includes a matrix structure 112 forming a plurality of capillaries 114, and the braze material 110 is disposed within the plurality of capillaries 114, contacting the first surface 102 and the second surface 104. The braze material 110, the capillary matrix 108, the first surface 102, the second surface 104, and the gap 106 form a brazed portion 202.

The brazed portion 202 may include any suitable level of voiding. In one embodiment, the brazed portion includes less than about 20% voiding, alternatively less than about 15% voiding, alternatively less than about 10% voiding, alternatively less than about 7.5% voiding, alternatively less than about 5% voiding, alternatively less than about 2.5% voiding, alternatively less than about 2% voiding, alternatively less than about 1% voiding, alternatively less than about 0.5% voiding, alternatively less than about 0.1% voiding.

The brazed portion 202 may be substantially free of eutectic phase, alternatively free of eutectic phase. In one embodiment, “substantially free” indicates less than about 1% eutectic phase, alternatively less than about 0.5% eutectic phase, alternatively less than about 0.1% eutectic phase, alternatively less than about 0.01% eutectic phase, alternatively less than about 0.001% eutectic phase.

Referring to FIGS. 1 and 2, in one embodiment (FIG. 1), the first surface 102 is of a first article 116, and the second surface 104 is of a second article 118, wherein the first article 116 is distinct from and not directly joined to the second article 118, whereas in another embodiment (FIG. 2), the first surface 102 and the second surface 104 are of a unitary article 204. In one embodiment, the first surface 102, the second surface 104, and the gap 106 constitute a seal slot. In a further embodiment, the seal slot is a gas turbine seal slot. In yet a further embodiment, the gas turbine seal slot is a shroud seal slot, a nozzle (vane) seal slot, or a transition piece seal slot. In another embodiment, the first surface 102, the second surface 104, and the gap 106 constitute a machined channel. In a further embodiment, the machined channel is formed by the removal of an undesired feature from an article.

The matrix structure 112 may include any suitable structure, including, but not limited to a cross-linked metallic matrix 120 (shown), and interwoven metallic matrix, a non-woven metallic matrix, or combinations thereof. In one embodiment, the plurality of capillaries 114 are in fluid communication with one another.

The matrix structure 112 may include any suitable pore size, including, but not limited to, a pore size of up to about 150 μm, alternatively up to about 100 μm, alternatively between about 1 μm to about 100 μm, alternatively between about 1 μm to about 100 μm, alternatively between about 1 μm to about 40 μm, alternatively between about 20 μm to about 60 μm, alternatively between about 40 μm to about 80 μm, alternatively between about 60 μm to about 100 μm, alternatively between about 1 μm to about 20 μm, alternatively between about 15 μm to about 35 μm, alternatively between about 30 μm to about 50 μm, alternatively between about 45 μm to about 65 μm, alternatively between about 60 μm to about 80 μm, alternatively between about 75 μm to about 100 μm.

The capillary matrix 108 may include any suitable material, including, but not limited to, superalloys, nickel-based superalloys, cobalt-based superalloys, iron-based superalloys, HTW alloys, NW alloys, refractory alloys, iron-based alloys, steel alloys, stainless steel alloys, cobalt-based alloys, nickel-based alloys, FSX 414, HASTALLOY X, GTD 111, GTD 222, HAYNES 188, HAYNES 230, INCONEL 600, INCONEL 625, INCONEL 738, INCONEL 939, MAR-M-247, MAR-M-509, René 108, René N5, or combinations thereof.

In one embodiment, at least one of the first surface 102 and the second surface 104 (alternatively both of the first surface 102 and the second surface 104) independently includes at least one of an iron-based alloy, a steel, a stainless steel, a carbon steel, a nickel-based alloy, a cobalt-based alloy, a titanium-aluminum alloy, a superalloy, a nickel-based superalloy, a cobalt-based superalloy, an iron-based superalloy, an HTW alloy, am NW alloy, a refractory alloy, GTD 111, GTD 222, GTD 444, INCONEL 100, INCONEL 738, INCONEL 939, MAR-M-247, René 108, René N5, or combinations thereof. In a further embodiment, both of the first surface 102 and the second surface 104 include an HTW alloy or an NW alloy.

The braze material 110 may include any suitable composition. In one embodiment, the braze material 110 includes a first material. The first material may include a braze alloy, DF-4B, D15, MAR-M-509B, BNi-2, BNi-3, BNi-5, BNi-6, BNi-7, BNi-9, BNi-10, or combinations thereof. In another embodiment, in addition to the first material, the braze material 110 further includes a second material. The second material may include an alloy including a melting point higher than the first material, HAYNES 188, HAYNES 230, L605, MAR-M-247, MAR-M-509, René 108, or combinations thereof. The first material and the second material may be uniformly distributed, alternatively essentially uniformly distributed, alternatively non-uniformly distributed, throughout the braze material 110. As used herein, “essentially uniformly distributed” indicates that there is a less than 10% variance in the distribution, and “non-uniformly distributed” indicates a greater than 10% variance in the distribution.

The braze material 110 may include any suitable amount of the first material and the second material. In one embodiment, the braze material 110 includes a weight ratio of the second material to the first material of between about 95:5 to about 20:80, alternatively between about 90:10 to about 30:70, alternatively between about 85:15 to about 35:65. In a further embodiment, the braze material 110 consists essentially of the first material and the second material, excluding impurities forming less than about 3% of the braze material 110, alternatively less than about 2% of the braze material 110, alternatively less than about 1% of the braze material 110.

As used herein, “BNi-2” refers to an alloy including a composition, by weight, of about 3% iron, about 3.1% boron, about 4.5% silicon, about 7% chromium, and a balance of nickel.

As used herein, “BNi-3” refers to an alloy including a composition, by weight, of about 4.5% silicon, about 3% boron, and a balance of nickel.

As used herein, “BNi-5” refers to an alloy including a composition, by weight, of about 10% silicon, about 19% chromium, and a balance of nickel.

As used herein, “BNi-6” refers to an alloy including a composition, by weight, of about 11% phosphorous and a balance of nickel.

As used herein, “BNi-7” refers to an alloy including a composition, by weight, of about 14% chromium, about 10% phosphorous, and a balance of nickel.

As used herein, “BNi-9” refers to an alloy including a composition, by weight, of about 15% chromium, about 3% boron, and a balance of nickel.

As used herein, “BNi-10” refers to an alloy including a composition, by weight, of about 11.5% chromium, about 3.5% silicon, about 2.5% boron, about 3.5% iron, about 0.5% carbon, about 16% tungsten, and a balance of nickel.

As used herein, “DF-4B” refers to an alloy including a composition, by weight, of about 14% chromium, about 10% cobalt, about 3.5% aluminum, about 2.5% tantalum, about 2.75% boron, about 0.05% yttrium, and a balance of nickel.

As used herein, “D15” refers to an alloy including a composition, by weight, of about 15% chromium, about 10.25% cobalt, about 3.5% tantalum, about 3.5% aluminum, about 2.3% boron, and a balance of nickel.

As used herein, “FSX 414” refers to an alloy including a composition, by weight, of about 29% chromium, about 7% tungsten, about 10% nickel, about 0.6% carbon, and a balance of cobalt.

As used herein, “GTD 111” refers to an alloy including a composition, by weight, of about 14% chromium, about 9.5% cobalt, about 3.8% tungsten, about 4.9% titanium, about 3% aluminum, about 0.1% iron, about 2.8% tantalum, about 1.6% molybdenum, about 0.1% carbon, and a balance of nickel.

As used herein, “GTD 222” refers to an alloy including a composition, by weight, of about 23.5% chromium, about 19% cobalt, about 2% tungsten, about 0.8% niobium, about 2.3% titanium, about 1.2% aluminum, about 1% tantalum, about 0.25% silicon, about 0.1% manganese, and a balance of nickel.

As used herein, “GTD 444” refers to an alloy including a composition, by weight, of about 7.5% cobalt, about 0.2% iron, about 9.75% chromium, about 4.2% aluminum, about 3.5% titanium, about 4.8% tantalum, about 6% tungsten, about 1.5% molybdenum, about 0.5% niobium, about 0.2% silicon, about 0.15% hafnium, and a balance of nickel.

As used herein, “HASTELLOY X” refers to an alloy including a composition, by weight, of about 22% chromium, about 18% iron, about 9% molybdenum, about 1.5% cobalt, about 0.1% carbon, about 0.6% tungsten, and a balance of nickel.

As used herein, “HAYNES 188” refers to an alloy including a composition, by weight, of about 22% chromium, about 22% nickel, about 0.1% carbon, about 3% iron, about 1.25% manganese, about 0.35% silicon, about 14% tungsten, about 0.03% lanthanum, and a balance of cobalt.

As used herein, “HAYNES 230” refers to an alloy including a composition, by weight, of about 22% chromium, about 2% molybdenum, about 0.5% manganese, about 0.4% silicon, about 14% tungsten, about 0.3% aluminum, about 0.1% carbon, about 0.02% lanthanum, and a balance of nickel.

As used herein, “INCONEL 100” refers to an alloy including a composition, by weight, of about 10% chromium, about 15% cobalt, about 3% molybdenum, about 4.7% titanium, about 5.5% aluminum, about 0.18% carbon, and a balance of nickel.

As used herein, “INCONEL 600” refers to an alloy including a composition, by weight, of about 15.5% chromium, about 8% iron, about 1% manganese, about 0.5% copper, about 0.5% silicon, about 0.15% carbon, and a balance of nickel.

As used herein, “INCONEL 625” refers to an alloy including a composition, by weight, of about 21.5% chromium, about 5% iron, about 9% molybdenum, about 3.65% niobium, about 1% cobalt, about 0.5% manganese, about 0.4% aluminum, about 0.4% titanium, about 0.5% silicon, about 0.1% carbon, and a balance of nickel.

As used herein, “INCONEL 738” refers to an alloy including a composition, by weight, of about 0.17% carbon, about 16% chromium, about 8.5% cobalt, about 1.75% molybdenum, about 2.6% tungsten, about 3.4% titanium, about 3.4% aluminum, about 0.1% zirconium, about 2% niobium, and a balance of nickel.

As used herein, “INCONEL 939” refers to an alloy including a composition, by weight, of about 0.15% carbon, about 22.5% chromium, about 19% cobalt, about 2% tungsten, about 3.8% titanium, about 1.9% aluminum, about 1.4% tantalum, about 1% niobium, and a balance of nickel.

As used herein, “L605” refers to an alloy including a composition, by weight, of about 20% chromium, about 10% nickel, about 15% tungsten, about 0.1% carbon, and a balance of cobalt.

As used herein, “MAR-M-247” refers to an alloy including a composition, by weight, of about 5.5% aluminum, about 0.15% carbon, about 8.25% chromium, about 10% cobalt, about 10% tungsten, about 0.7% molybdenum, about 0.5% iron, about 1% titanium, about 3% tantalum, about 1.5% hafnium, and a balance of nickel.

As used herein, “MAR-M-509” refers to an alloy including a composition, by weight, of about 24% chromium, about 10% nickel, about 7% tungsten, about 3.5% tantalum, about 0.5% zirconium, about 0.6% carbon, and a balance of cobalt.

As used herein, “MAR-M-509B” refers to an alloy including a composition, by weight, of about 23.5% chromium, about 10% nickel, about 7% tungsten, about 3.5% tantalum, about 0.45% zirconium, about 2.9% boron, about 0.6% carbon, about 0.2% titanium, and a balance of cobalt.

As used herein, “René 108” refers to an alloy including a composition, by weight, of about 8.4% chromium, about 9.5% cobalt, about 5.5% aluminum, about 0.7% titanium, about 9.5% tungsten, about 0.5% molybdenum, about 3% tantalum, about 1.5% hafnium, and a balance of nickel.

As used herein, “René N5” refers to an alloy including a composition, by weight, of about 7.5% cobalt, about 7.0% chromium, about 6.5% tantalum, about 6.2% aluminum, about 5.0% tungsten, about 3.0% rhenium, about 1.5% molybdenum, about 0.15% hafnium, and a balance of nickel.

The gap 106 may include any suitable gap width 122. In one embodiment, the gap width 122 is between about 0.03 inches and about 0.5 inches, alternatively between about 0.03 inches to about 0.25 inches, alternatively between about 0.1 inches to about 0.35 inches, alternatively between about 0.2 inches to about 0.5 inches, alternatively between about 0.03 inches to about 0.1 inches, alternatively between about 0.1 inches to about 0.2 inches, alternatively between about 0.2 inches to about 0.3 inches, alternatively between about 0.3 inches to about 0.4 inches, alternatively between about 0.4 inches to about 0.5 inches, alternatively less than about 0.5 inches, alternatively less than about 0.45 inches, alternatively at least about 0.03 inches, alternatively at least about 0.05 inches.

In one embodiment, a method for forming a brazed article 200 includes disposing a capillary matrix 108 into a gap 106 between a first surface 102 and a second surface 104, infusing a braze material 110 into the plurality of capillaries 114 of the capillary matrix 108, and contacting the braze material 110 to the first surface 102 and the second surface 104, forming a brazed portion 202.

Disposing the capillary matrix 108 into the gap 106 may include press-fitting the capillary matrix 108 into the gap 26. In one embodiment, press-fitting the capillary matrix 108 into the gap 106 includes the capillary matrix 108 having a capillary matrix width 124 between 0.004 inches smaller to about 0.01 inches larger than the gap width 122, alternatively between 0.002 inches smaller to about 0.008 inches larger than the gap width 122, alternatively between 0.001 inches smaller to about 0.007 inches larger than the gap width 122.

Infusing the braze material 110 into the plurality of capillaries 114 may include drawing the braze material 110 through the capillary matrix 108 by sequential capillary action through fluid communication amongst the plurality of capillaries 114. Infusing the braze material 10 into the plurality of capillaries 114 may further including gravitational assist.

In one embodiment, forming the brazed portion 202 includes forming less than about 15% voiding, alternatively less than about 10% voiding, alternatively less than about 7.5% voiding, alternatively less than about 5% voiding, alternatively less than about 2.5% voiding, alternatively less than about 2% voiding, alternatively less than about 1% voiding, alternatively less than about 0.5% voiding, alternatively less than about 0.1% voiding. In another embodiment, forming the brazed portion 202 may be substantially free of forming eutectic phase in the brazed portion 202, alternatively free of forming eutectic phase in the brazed portion.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A braze system, comprising:
a first surface;
a second surface;
a gap disposed between the first surface and the second surface;
a capillary matrix disposed in the gap, the capillary matrix including a matrix structure forming a plurality of capillaries; and
a braze material disposed in contact with the capillary matrix.

2. The braze system of claim 1, wherein the matrix structure includes a cross-linked metallic matrix.

3. The braze system of claim 2, wherein the matrix structure includes up to a 100 μm pore size.

4. The braze system of claim 3, wherein the matrix structure includes between about a 20 μm to about a 60 μm pore size.

5. The braze system of claim 2, wherein the capillary matrix includes a material selected from the group consisting of superalloys, nickel-based superalloys, cobalt-based superalloys, iron-based superalloys, hard-to-weld alloys, non-weldable alloys, refractory alloys, iron-based alloys, steel alloys, stainless steel alloys, cobalt-based alloys, nickel-based alloys, FSX 414, GTD 111, GTD 222, HASTALLOY X, HAYNES 188, HAYNES 230, INCONEL 600, INCONEL 625, INCONEL 738, INCONEL 939, MAR-M-247, MAR-M-509, René 108, René N5, and combinations thereof.

6. The braze system of claim 1, wherein the plurality of capillaries are in fluid communication with one another.

7. The braze system of claim 1, wherein at least one of the first surface and the second surface independently includes a material selected from the group consisting of iron-based alloys, steels, stainless steels, carbon steels, nickel-based alloys, cobalt-based alloys, titanium-aluminum alloys, superalloys, nickel-based superalloys, cobalt-based superalloys, iron-based superalloys, hard-to-weld alloys, non-weldable alloys, refractory alloys, GTD 111, GTD 222, GTD 444, INCONEL 100, INCONEL 738, INCONEL 939, MAR-M-247, René 108, René N5, and combinations thereof.

8. The braze system of claim 1, wherein at least one of the first surface and the second surface includes a hard-to-weld alloy or a non-weldable alloy.

9. The braze system of claim 1, wherein the braze material includes a first material selected from the group consisting of a braze alloy, DF-4B, D15, MAR-M-509B, BNi-2, BNi-3, BNi-5, BNi-6, BNi-7, BNi-9, BNi-10, and combinations thereof.

10. The braze system of claim 9, further including a second material selected from the group consisting of an alloy including a melting point higher than the first alloy, HAYNES 188, HAYNES 230, L605, MAR-M-247, MAR-M-509, René 108, and combinations thereof, wherein, braze material includes a weight ratio of the second material to the first material of between about 95:5 to about 20:80.

11. The braze system of claim 1, wherein the gap includes a gap width between about 0.03 inches and about 0.5 inches.

12. The braze system of claim 1, wherein the first surface, the second surface and the gap constitute a seal slot.

13. The braze system of claim 12, wherein the seal slot is a gas turbine seal slot, and the gas turbine seal slot is a shroud seal slot, and nozzle (vane) seal slot, or a transition piece seal slot.

14. The braze system of claim 1, wherein the first surface, the second surface and the gap constitute a machined channel.

15. A brazed article, comprising:
a first surface;
a second surface;
a gap disposed between the first surface and the second surface;
a capillary matrix disposed in the gap, the capillary matrix including a matrix structure forming a plurality of capillaries; and
a braze material disposed within the plurality of capillaries and contacting the first surface and the second surface, the braze material, the capillary matrix, the first surface, the second surface, and the gap forming a brazed portion,
wherein the brazed portion includes less than about 20% voiding.

16. A method for forming a brazed article, comprising:
disposing a capillary matrix into a gap between a first surface and a second surface, the capillary matrix including a matrix structure forming a plurality of capillaries; and
infusing a braze material into the plurality of capillaries and contacting the braze material to the first surface and the second surface, forming a brazed portion.

17. The method of claim 16, wherein infusing the braze material into the plurality of capillaries includes drawing the braze material through the capillary matrix by sequential capillary action through fluid communication amongst the plurality of capillaries.

18. The method of claim 16, wherein forming the brazed portion includes forming less than about 20% voiding and is substantially free of forming eutectic phases.

19. The method of claim 16, wherein infusing the braze material includes brazing across a gap width between about 0.03 inches and about 0.5 inches.

20. The method of claim 16, wherein disposing the capillary matrix into the gap includes press-fitting the capillary matrix into the gap, the capillary matrix including a capillary matrix width between 0.002 inches smaller to about 0.008 inches larger than a gap width.

21. A braze system, comprising:
a first surface;
a second surface;
a gap disposed between the first surface and the second surface, wherein the first surface, the second surface and the gap constitute a gas turbine seal slot, and the gas turbine seal slot is one of a shroud seal slot, and nozzle or vane seal slot, or a transition piece seal slot;
a capillary matrix disposed in the gap, the capillary matrix including a matrix structure forming a plurality of capillaries, wherein the matrix structure includes a cross-linked metallic matrix and the matrix structure includes between a 20 μm to a 60 μm pore size; and
a braze material disposed in contact with the capillary matrix.

22. The braze system of claim 21, wherein the capillary matrix includes a material selected from the group consisting of superalloys, nickel-based superalloys, cobalt-based superalloys, iron-based superalloys, hard-to-weld alloys, non-weldable alloys, refractory alloys, iron-based alloys, steel alloys, stainless steel alloys, cobalt-based alloys, or nickel-based alloys, and combinations thereof.

23. The braze system of claim 22, wherein at least one of the first surface and the second surface independently includes a material selected from the group consisting of iron-based alloys, steels, stainless steels, carbon steels, nickel-based alloys, cobalt-based alloys, titanium-aluminum alloys, superalloys, nickel-based superalloys, cobalt-based superalloys, iron-based superalloys, hard-to-weld alloys, non-weldable alloys, refractory alloys, and combinations thereof.

24. The braze system of claim 23, wherein at least one of the first surface and the second surface includes a hard-to-weld alloy or a non-weldable alloy.

25. The braze system of claim 23, wherein the braze material includes a first material selected from the group consisting of a braze alloy, DF-4B, D15, MAR-M-509B, BNi-2, BNi-3, BNi-5, BNi-6, BNi-7, BNi-9, BNi-10, and combinations thereof.

26. The braze system of claim 25, further including a second material selected from the group consisting of an alloy including a melting point higher than the first alloy, HAYNES 188, HAYNES 230, L605, MAR-M-247, MAR-M-509, René 108, and combinations thereof, wherein, braze material includes a weight ratio of the second material to the first material of between about 95:5 to about 20:80.
